(19) United States
(12) Patent Application Publication
(10) Pub. No.: US 2009/0115209 A1
(43) Pub. Date: May 7, 2009

(54) Carrier Support for Attaching to a Motor Vehicle

(76) Inventor: Russell W Roth, Columbus, OH (US)

Correspondence Address: Bernhard P. Molldrem, Jr., 224 Harrison Street, Syracuse, NY, 13202, US

(21) Appl. No.: 11/933,640

(22) Filed: Nov. 1, 2007

(51) Int. Cl. B60R 9/06

(52) U.S. Cl. 293/155

(57) ABSTRACT

A carrier support arrangement that attaches to a vehicle between a rear bumper crash bar and mounting pads that are provided at the rear of the body of the vehicle. The carrier support is formed of a transverse support bar that has a modified C-channel beam construction, with attachment lands formed at end portions. The beam has cantilever bars affixed to it that project forward and sockets or ports that extend rearward. The structure of the support bar accommodates the crash absorber bar of the vehicle bumper frame, and achieves a weight savings over earlier construction.

### BACKGROUND OF THE INVENTION

This invention relates to mounts for attaching a trailer hitch, bike rack, ski rack, or other carrier system for a motor vehicle. The invention is more particularly concerned with a support arrangement that attaches to a vehicle between a rear bumper crash bar and mounts therefor that are provided at the rear of the body of the vehicle.

The device of this invention may be employed on an automobile of the type in which the rear bumper is mounted onto the body of the vehicle, which may be a sedan or other light vehicle. The vehicle design allows for a structural bumper support, e.g., a crash bar, to be mounted on spaced apart attachment pads on the vehicle body. Then the decorative cover of the bumper is mounted over the crash bar. There may be conventional bumper components provided, such as a foam shock absorber. A transverse support beam for the carrier device has left and right plates, or lands, which are apertured so they may be bolted in place, and these are sandwiched between the vehicle attachment pads and the bumper crash bar. The support beam has cantilever bars that project forward and mount into rectangular tube members that are part of the vehicle, and also has a pair of tubular receptacles or ports that project to rearward. The ports serve as sockets into which the trailer hitch, bike rack, ski rack, or other carrier device is mounted.

A prior model load carrier of this type is described in U.S. Pat. No. 6,827,377 to Ferrigan. In that model, the transverse support beam is made of a heavy grade steel, and consequently the device adds considerably to the vehicle weight. The transverse beam is formed of a heavy gauge steel, and has full flanges at the upper and lower edges of the beam web.

The rear bumper design for the recent model years for one vehicle on which this arrangement can be installed, namely the Mini™, of which several models (e.g., Cooper, Cooper D, Cooper S, Clubman) are available, has a special foam rubber crash absorber situated on the forward side of the crash bar, and this has to rest in a channel on the rear of the vehicle body. The prior model of load carrier does not accommodate the foam crash absorber.

### OBJECTS AND SUMMARY OF THE INVENTION

Accordingly, it is an object of the present invention to improve the weight and utility aspects of the support on which a trailer hitch, bike rack, ski rack or the like can be installed.

It is another object to provide a carrier support which can be employed for models of bumpers which have a foam crash absorber, and can also be employed with earlier models of bumpers which do not have a foam crash absorber.

A more specific object was to create an improved design for the carrier support so that it could be made lighter in weight without sacrifice of strength or durability.

In accordance with one aspect of the present invention, a carrier support is provided which attaches to a motor vehicle of the type in which there are rear bumper attachment pads for mounting a frame, e.g., a crash bar, of the rear bumper. That is, the carrier support is mounted onto the rear bumper attachment pads, between the latter and the bumper crash bar on which the rear bumper is mounted. The carrier support is basically formed of a transverse support beam, with left and right support lands formed at ends of the transverse support beam. These lands are adapted to be mounted onto respective ones of the bumper attachment pads. A pair of cantilevered mounting bars are affixed onto the transverse support beam and extend forward i.e., towards the front of the vehicle. These cantilevered bars are intended mate with corresponding square tubular supporting structure at the rear of said motor vehicle. A pair of spaced-apart tubular socket members or ports are affixed to the transverse support beam and these extend rearward therefrom, i.e., the opposite direction from the cantilevered mounting bars. These ports or tubular socket members serve to receive attachment rods of a carrier device to that is to be removably supported thereon. This structure, to this point, generally corresponds to what is shown in earlier U.S. Pat. No. 6,827,377.

However, in this invention, the transverse support beam is improved in that it is formed as a modified C-channel, as shown in the accompanying Drawing Figures and as herein described. The transverse support beam has a web with upper and lower flanges. The upper flange extends rearward from upper edge of the web for a first flange width, and the lower flange extends rearward from the lower edge of the web for a second flange width. The lower flange has a reinforcing lip extending downward from the rear edge of the lower flange.

In a preferred version, the first flange width (of the upper flange) is substantially five-eighths of the second flange width (of the lower flange). In this embodiment, the upper edge of the web at which the upper flange is joined is a curve having a radius of substantially three-quarters inch; the lower edge of the web at which said lower flange is joined is a curve having a radius of substantially one-quarter inch; a fin flange extends forward from a lower edge of the reinforcing lip; and a lip extends somewhat downward from a rear edge of the upper flange.

This particular shape has a dual benefit, in that (a) the interior of this modified C-channel will accommodate the forward foot portion of the bumper crash absorber pad, and at the same time can be installed without difficulty on the earlier models which have the crash bar without this crash absorber pad; and (b) the carrier support can be formed of a lighter gauge steel without sacrifice of strength, so that the carrier support is six to twelve pounds lighter than the version as described in the prior U.S. Pat. No. 6,827,377.

In some preferred versions, the transverse support beam can be extruded of an aluminum alloy, providing even greater weight savings.

The carrier support also is formed with left and right diagonal gussets formed at respective end portions of the transverse support beam. These each extend along an edge of the associated land.

Once the carrier support is suitably bolted in place on the bumper mounting pads of the vehicle, the bumper frame or crash bar is mounted on top of the carrier support, and the decorative plastic bumper cover is mounted onto the crash bar. Because the cover is made of a plastic resin material, openings can be formed easily into the cover to accommodate the two ports or sockets.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWING

FIG. 1 is a perspective view of the carrier support device according to one embodiment of the present invention.

FIG. 2 is cross section of the carrier support taken at approximately the vehicle mid line.

FIG. 3 is a rear elevation thereof.

FIG. 4 is a top plan view thereof.

FIG. 5 is bottom plan view thereof.

FIG. 6 is a cross section of the transverse beam member of the carrier support device of this embodiment, and of the bumper crash bar and crash absorber pad, with cantilever bar and port or socket shown in dash lines.

FIG. 7 is a rear perspective a motor vehicle onto which the carrier support is to be mounted, and with the bumper frame and crash bar and decorative cover being removed for access to the vehicle's rear bumper attachment pads.

FIG. 8 is a perspective view of the motor vehicle showing the rear bumper assembly reattached, and with the tubular sockets or ports of the carrier support being exposed through the rear bumper decorative cover.

### DETAILED DESCRIPTION OF THE PREFERRED EMBODIMENT

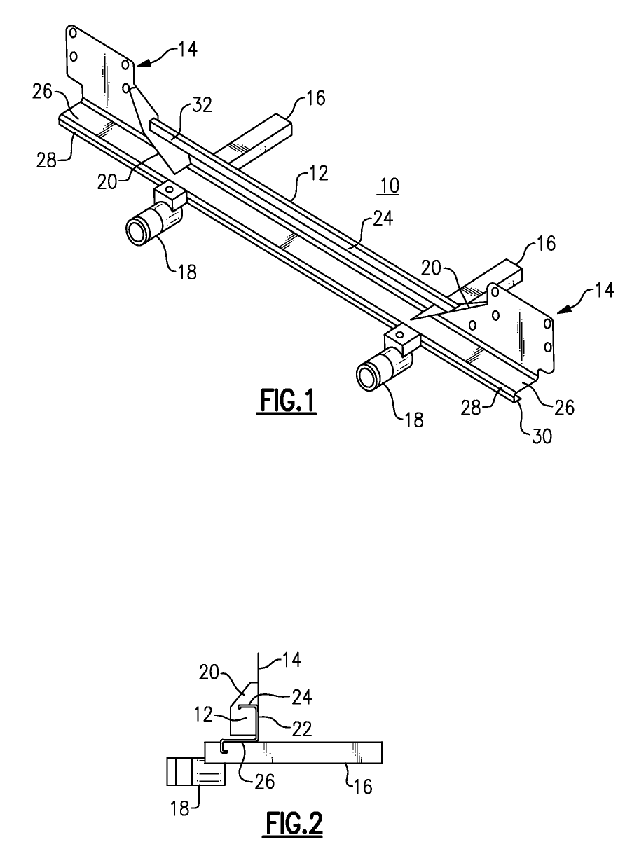

With reference now to the Drawing, and initially to FIG. 1, a support device 10 for a carrier is shown according to one possible embodiment of this invention. The carrier may be, for example, a bike rack, ski rack, trailer ball hitch, or other similar item that is mounted at the rear of a motor vehicle to hold or carry some item or cargo. This support device is intended to be mounted onto bumper attachment pads that are provided at the rear of the vehicle, and may be affixed to the vehicle generally as discussed in prior U.S. Pat. No. 6,827,377. The support device comprises a transverse support beam 12, which is generally in the form of a modified C-channel, as described in detail below, with web, flanges, and reinforcing lips and fins. There are attachment lands 14, i.e., flat apertured panels, situated at left and right end portions of the support beam 12, and these serve as the means for attachment to the vehicle, and are sandwiched between the vehicle rear bumper attachment pads and rear bumper crash bar or frame, as also discussed in U.S. Pat. No. 6,827,377.

The carrier support 10 is provided with a pair of cantilever mounting bars 16, spaced apart along the support beam and affixed at an underside thereof. These cantilever bars 16 project forward (i.e., toward the front of the vehicle), and are intended as male members that fit into respective square tubular members that are present on the vehicle, and where they may be fixed in place. These bars 16 may preferably be rectangular profile hollow tubular members.

Left and right tubular sockets or attachment ports 18 are also affixed to the transverse support beam 12 at spaced locations. These may be directly affixed (i.e., welded, riveted or bolted) to the support beam or may be attached to the cantilever bars 16, as shown. These ports 18 serve as female members for receiving male attachment rods (not shown) on the carrier device for mounting to the carrier support 10.

There are also gussets 20 that are oriented in a plane that is slanted and these proceed across the end portions of the transverse support beam 12 and each proceeds along an inside edge of a respective one of the attachment lands 14.

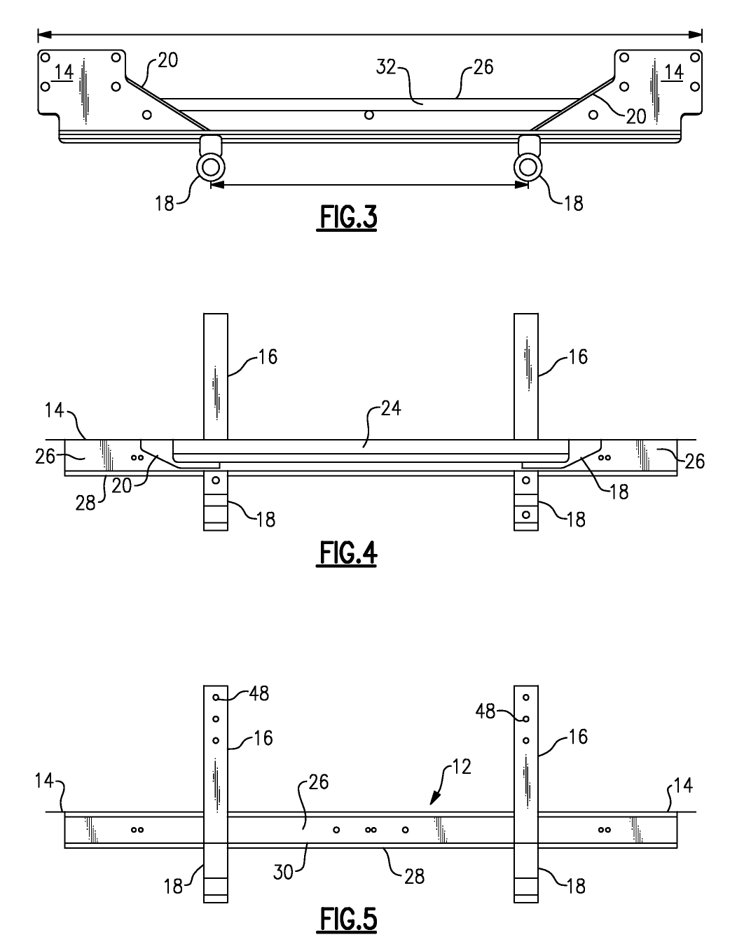

The details of the support beam 12 and orientation of the various components as discussed above are shown in FIGS. 2 and 3 to 5. FIG. 2 illustrates the general modified C-channel profile of the central portion of the support beam 12. The support beam has a web 22 that is generally in a vertical plane, facing against the rear part of the vehicle body, with an upper flange 24 that extends from an upper edge to rearward and a lower flange 26 that extend from the web 22 lower edge to rearward. In this embodiment, the lower flange 26 has a flange width that is substantially the same as the web depth; the upper flange 24 has a flange width that is about five-eighths that dimension. The lower flange 26 has a reinforcing lip 28 that proceeds downwards from the rear edge of the lower flange 26, and a reinforcing fin flange 30 that extends forward from the bottom edge of the lip 28. Also shown in this embodiment, an upper fin flange 32 is formed at the rear edge of the upper flange 24 and this fin flange extends a short distance in a generally downward direction.

As seen in FIGS. 1 and 3, the web 22, lower flange 26, lip 28 and fin flange 30 continue beneath the ends of the support beam where the attachment lands 14 are formed, whereas the upper flange 24 terminates at the locations of the gussets 20.

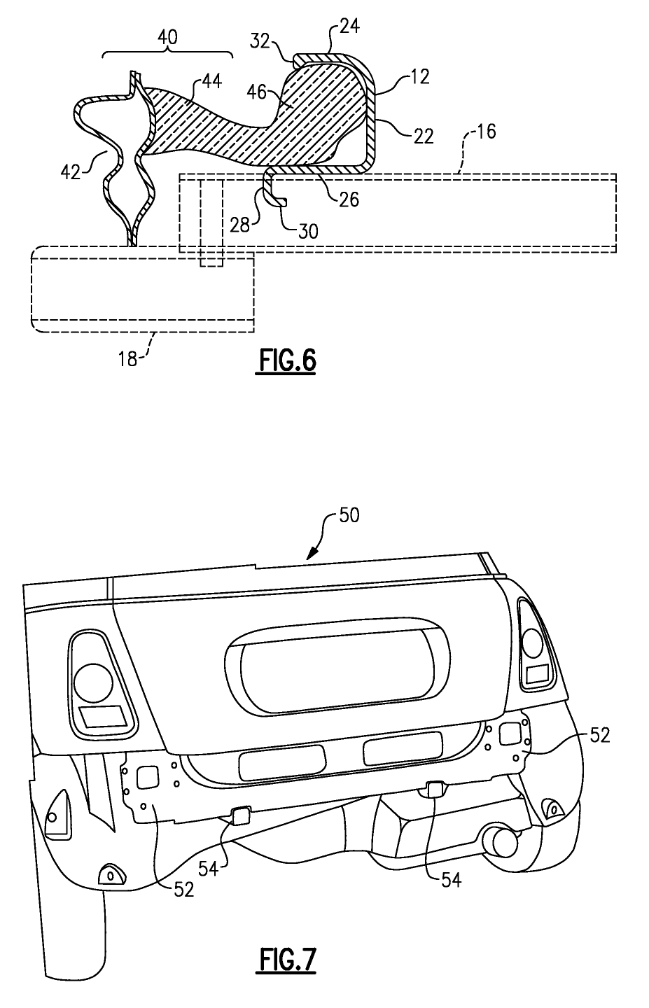

FIG. 6 illustrates a practical embodiment of this carrier support, shown in conjunction with a bumper support frame 40. The bumper support frame includes a crash bar 42, that here is formed of a pair of stampings of high strength steel, the two stampings being curved as shown to form front and back halves that are affixed to one another, with a resilient foam crash absorber pad 44 attached to the forward side of the crash bar 42. The crash absorber pad 44 has a foot portion 46 at its forward end, which was designed to fit structure of the body wall at the rear end of the vehicle. In this embodiment, the crash absorber foot portion 46 fits inside the C-channel of the support bar 12, against the web 22 and between the upper and lower flanges 24, 26.

In the structure shown in FIG. 6, the support bar 12 is formed with a curved edge portion 34 that joins the web and upper flange 24, the portion 34 here having an inside radius of three-quarters inch. A lower curved edge 36 of the web 22 where the lower flange 26 is formed has an inside radius of a one-quarter inch. The web depth here is about 2.7 inches, the upper flange width is 1.7 inches, and the lower flange depth is 2.7 inches. The lip width of the reinforcing lip 28 is about three-quarters inch. The lower fin flange 30 projects back about one-half inch, and the upper fin flange 32 extends down about one-eighth inch. The steel used in forming the transverse support bar 12 has a thickness of about 0.135 inches, i.e., #10 gauge grade 80 steel, that is 80 KSI minimum yield strength.

The cantilever bars 14 are preferably 1½ inch by 1½ inch steel tube, with a wall thickness of 3/16 inch. There are tapped eight millimeter holes 48 in these bars 14, and these holes 48 are aligned with holes in the vehicle frame that serve as hangers for muffler brackets.

The sockets or ports 18 are round steel tube with an inner diameter of about 1 1/16 inch to receive the horizontal bolts or posts of the carrier device.

The carrier support device 10 of this invention has several advantages over the support device that was shown and described in the prior U.S. Pat. No. 6,827,337. The modified C-channel beam structure formed of high-strength steel allows the assembly weight to be reduced by approximately twelve pounds, without sacrifice of structural strength. Also, the cross-sectional shape of the transverse support beam allows the carrier support device 10 to receive the crash absorber pad 44 without modification to the pad 44. At the same time, the carrier support device 10 of the embodiment(s) of this invention can be fitted onto earlier models of the vehicle, where their rear bumper frames do not have the crash absorber pad.

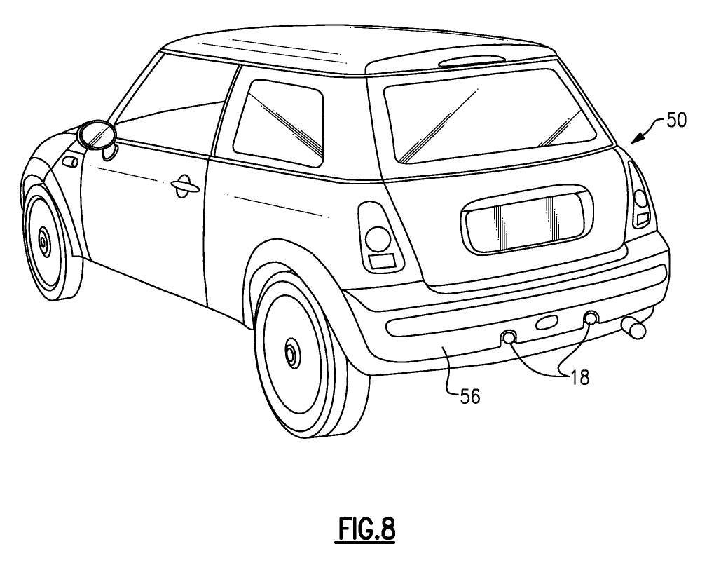

FIGS. 7 and 8 are provided to show the manner of mounting of the carrier support device 10 at the rear of a vehicle 50. FIG. 7 shows the vehicle 50 with the rear bumper removed, both cover and frame, to expose a rear body panel where the bumper attachment pads 52 are located. This view also shows square cross-section receptacles 54, in which the cantilever bars 16 are received. The attachment lands 14 of the carrier support member are bolted in place onto the attachment lands, and then the rear bumper frame is reinstalled, also using the same attachment pads. The decorative cover 56 is installed over the rear bumper frame, as shown in FIG. 8. Prior to reinstallation of the cover 56, openings are formed in the cover for the tubular ports 18.

While the invention has been described with reference to specific preferred embodiments, the invention is certainly not limited to those precise embodiments. Rather, many modifications and variations will become apparent to persons of skill in the art without departure from the scope and spirit of this invention, as defined in the appended claims.

I claim:

1. A carrier support for attaching to a motor vehicle between a set of rear bumper attachment pads of the motor vehicle and a bumper crash bar on which a rear bumper is mounted; the carrier support comprising
a transverse support beam;
left and right support lands formed at ends of the transverse support beam and adapted to be mounted onto respective ones of the bumper attachment pads;
a pair of mounting bars affixed onto said transverse support beam and extending forward therefrom to mate with corresponding square tubular members located at the rear of said motor vehicle; and
a pair of spaced-apart tubular socket members affixed to said transverse support beam and extending rearward therefrom, said tubular socket members being adapted to receive attachment rods of a carrier device to that is to be removably supported thereon;
wherein said transverse support beam is a modified C-channel having a web that has upper and lower edges, an upper flange extending rearward from said upper edge for a first flange width, a lower flange extending rearward from the lower edge of said web for a second flange width, and a reinforcing lip extending downward from a rear edge of said lower flange.

2. The carrier support of claim 1 wherein said first flange width is substantially five-eighths of the second flange width.

3. The carrier support of claim 1 wherein said upper edge of the web at which said upper flange is joined is a curve having a radius of substantially three-quarters inch.

4. The carrier support of claim 1 wherein said lower edge of the web at which said lower flange is joined is a curve having a radius of substantially one-quarter inch.

5. The carrier support of claim 1 further comprising a fin flange extending forward from a lower edge of said reinforcing lip.

6. The carrier support of claim 1 further comprising a lip depending from a rear edge of said upper flange.

7. The carrier support of claim 1 wherein said transverse support beam is extruded of aluminum.

8. The carrier support of claim 1 comprising left and right diagonal gussets formed at respective end portions of said transverse support beam and extending along an edge of the respective lands.

9. The carrier support of claim 1 wherein said lower flange and reinforcing lip extend across said support beam below said left and right support lands.

10. The carrier support of claim 9 wherein said upper flange terminates at inside edges of said support lands.
